(19) United States
(12) Patent Application Publication
(10) Pub. No.: US 2025/0131940 A1
(43) Pub. Date: Apr. 24, 2025

(54) MULTI-TIME-SCALE NEURAL AUDIO CODEC STREAMS

(71) Applicant: Cisco Technology, Inc., San Jose, CA (US)

(72) Inventors: Rafal Pilarczyk, Plock (PL); Amir Salah Abdelsamie Abdelwahed, Edinburgh (GB); Hui-Ling Lu, Palo Alto, CA (US); Ivana Balic, Studen BE (CH); Yusuf Ziya Isik, Edinburgh (GB); David Guoqing Zhang, Fremont, CA (US); Xuehong Mao, San Jose, CA (US); Samer Lutfi Hijazi, San Jose, CA (US)

(21) Appl. No.: 18/539,764

(22) Filed: Dec. 14, 2023

Related U.S. Application Data
(60) Provisional application No. 63/591,181, filed on Oct. 18, 2023.

(51) Int. Cl. G10L 21/043; G10L 19/00

(52) U.S. Cl. CPC G10L 21/043; G10L 19/00

(57) ABSTRACT

A data-driven audio codec system that involves producing multiple compressed streams comprising encoded information (e.g., codeword indices) at different time scales (time intervals or frequency). This may allow for separation of different properties of speech, such as content and aspects of style (prosody), into the different compressed streams without explicitly enforcing it, i.e., in an unsupervised manner. Speech audio is encoded to produce a plurality of encoded streams comprising encoded information for the speech audio at different time scales. The plurality of encoded streams are decoded to generate output audio.

### PRIORITY CLAIM

This application claims priority to U.S. Provisional Application No. 63/591,181, filed Oct. 18, 2023, the entirety of which is incorporated herein by reference.

### TECHNICAL FIELD

The present disclosure relates to encoding and decoding audio.

### BACKGROUND

Current neural network audio codecs encode audio with arbitrary compression factors and generate codewords/tokens at fixed regular time intervals (frames). However, such a solution has its limitations, particularly in decoding such codewords. Models that operate on codewords produced at fixed time intervals can struggle with interpretation of objects represented by those codewords/speech tokens. For example, even minor non-perceptual alterations in the input audio signal, such as a slight change in signal level or a small shift in time or phase, can result in a radically different codeword output by the encoder. Thus, any decoder processing these codewords has to learn the appropriate distribution of codewords associated with the same audio event. Such a solution is not as effective in utilizing the limited space of codewords or the computation resources available at the decoder.

### BRIEF DESCRIPTION OF THE DRAWINGS

FIG. 1 is a system block diagram of a neural network audio codec system according to an example embodiment.

FIG. 2 is a diagram depicting end-to-end training of a neural network audio codec system according to an example embodiment.

FIG. 3 is a block diagram of a multi-time-scale neural network audio codec system according to an example embodiment.

FIG. 4 is a diagram depicting a system for training a slow-fast audio encoder with audio sharing the same phonetic content but different global attributes, according to an example embodiment.

FIG. 5 is a diagram depicting a system to for training an audio encoder to learn only certain attributes, according to an example embodiment.

FIG. 6 is a diagram depicting techniques for training an audio encoder by augmenting a given speech time interval or segment randomly in terms of speed or time shift, according to an example embodiment.

FIG. 7 is a diagram depicting the use of multiple encoded streams of different time scales to recover lost audio, according to an example embodiment.

FIG. 8 is a block diagram of a system that enables speech morphing using multiple encoded streams of different time scales, according to an example embodiment.

FIG. 9 is a block diagram of a system that predicts audio packets of encoded audio streams, according to an example embodiment.

FIG. 10 is a flow chart depicting a method for generating and using multiple encoded streams of different time scales, according to an example embodiment.

FIG. 11 is a hardware block diagram of a device that may be configured to perform the techniques presented herein, according to an example embodiment.

### DESCRIPTION OF EXAMPLE EMBODIMENTS

### Overview

Presented herein systems and methods for a data-driven audio coding approach that involves producing multiple compressed streams comprising encoded information (e.g., codeword indices) at different time scales (time intervals or frequency). This may allow for separation of different properties of speech, such as content and aspects of style (prosody), into the different compressed streams without explicitly enforcing it, i.e., in an unsupervised manner. Speech audio is encoded to produce a plurality of encoded streams comprising encoded information for the speech audio at different time scales. The plurality of encoded streams are decoded to generate output audio.

### Example Embodiments

### Neural Network Audio Codec System

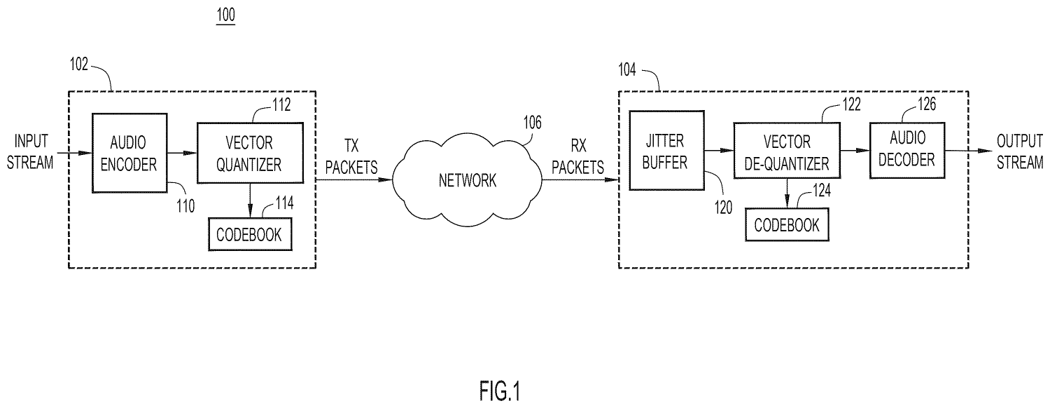

Reference is first made to FIG. 1. FIG. 1 shows a block diagram of a neural network audio encoder/decoder (codec) system 100. The neural network audio codec system 100 includes a transmit side 102 and a receive side 104, which may be separate at devices that are in communication with each other via network 106. The network 106 may be a combination of (wired or wireless) local area networks, (wired or wireless) wide area networks, public switched telephone network (PSTN), etc.

At the transmit side 102, there is an audio encoder 110 and a vector quantizer 112. The vector quantizer uses a codebook 114. The audio encoder 110 receives an input audio stream (that includes speech as well as artifacts and impairments). The audio encoder 110 may use a deep neural network that takes the input audio stream and transforms it frame-by-frame into high-dimensional embedding vectors that keep all the important information in the frame and optionally removes unwanted information such as the artifacts and impairments. The duration of the frames may be 10-20 millisecond (ms), for example. The audio encoder 110 may be composed of convolutional, recurrent, attentional, pooling, or fully connected neural layers as well as any suitable nonlinearities and normalizations. In one example, the audio encoder 110 uses a causal convolutional network with zero algorithm latency. The convolutional network may consist of convolutional blocks, and each convolutional block may be a stack of multiple residual units (1-dimensional (1-D) convolutional layer with residual connection) and finishes with a 1-D convolutional layer with stride for down-sampling. The vector quantizer 112 quantizes the high-dimensional embedding vectors at the output of the audio encoder 110. For example, the vector quantizer 112 may use techniques such as Residual Vector Quantization by selecting a set of codewords (from the codebook 114) from each layer to optimize a criterion reducing quantization error at the output stream on receive side. Thus, vector quantization is further compressing the embedding vectors into codewords, using a residual vector quantization model. The output of the vector quantization operation may also be referred to as compact or compressed speech vectors or compact speech tokens. The indices of the selected codewords for each frame are put into transmit (TX) packets and sent to the receive side 104, or they may be stored for later retrieval and use. In some implementations, the audio encoder 110 may generate the quantized vectors (indices) directly without the need for a separate vector quantizer 112. In other words, the vector quantization functions are incorporated into the audio encoder 110. The codeword indices are also referred to herein as tokens.

The receive side 104 obtains receive (RX) packets from the network 106. At the receive side 104, there are a jitter buffer 120, vector de-quantizer 122, codebook 124 and an audio decoder 126. The jitter buffer 120 keeps track of the incoming packets, putting them in order and deciding when to process and play a packet. The vector de-quantizer 122 de-quantizes received codeword indices and using the codebook 124, outputs recovered embedding vectors. The audio decoder 126 decodes the embedding vectors to produce an output audio stream. Again, in some implementations, the audio decoder 126 may generate the directly perform vector de-quantization without the need for a separate vector de-quantizer 122.

As an example, if the codebooks 114 and 124 have 1024 entries, then the codeword indices (tokens) can be 10-bits.

Though not specifically shown in FIG. 1 there may be an encoder, vector quantizer, vector de-quantizer and decoder at each device to enable two-way communications.

Techniques are provided for a generative artificial intelligence (AI) architecture built on the neural network audio codec system 100 shown in FIG. 1. At the core of this architecture is a compact speech vector that has great potential for a wide range of speech AI and other applications. The unified architecture offers a versatile solution applicable to various content, including but not limited to: speech enhancement (such as background noise removal, de-reverberation, bandwidth extension, gain control, and beamforming), packet loss concealment (with or without forward error correction (FEC)), acoustic speech recognition (ASR), speech synthesis, also referred to as text-to-speech (TTS), voice cloning and morphing, speech-to-speech translation (S2ST), and audio-driven large language model (AdLLM).

### Training the Neural Network Audio Codec System

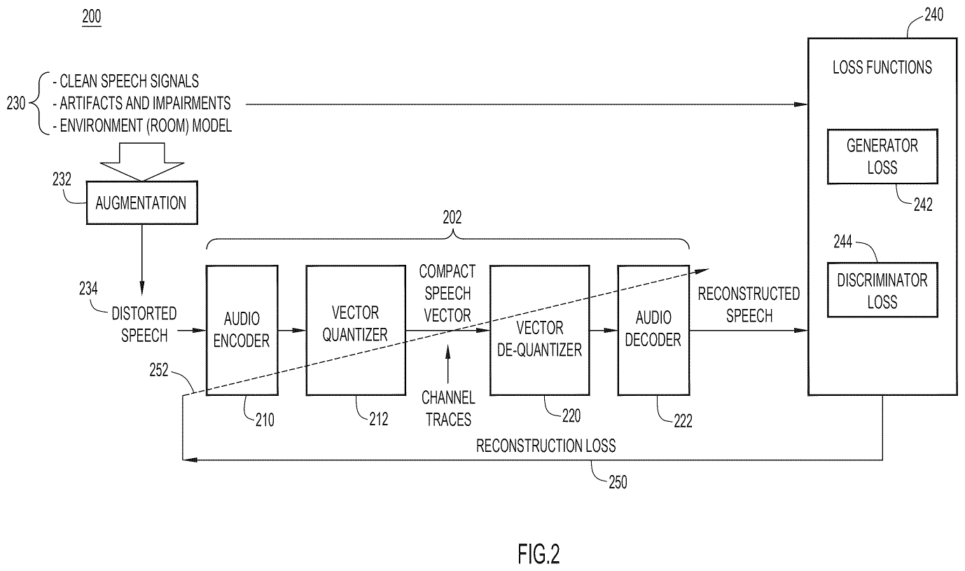

Reference is now made to FIG. 2. FIG. 2 shows an arrangement 200 by which components of a neural network audio codec system 202 are trained end-to-end using thousands of hours of speech and artifacts and impairments. Similar to FIG. 1, the neural network audio codec system 202 includes an audio encoder 210, vector quantizer 212, vector de-quantizer 220 and audio decoder 222, and each of these components may use a neural network model (or more generally machine learning-based model) for their operations.

To train the neural network audio codec system 202, as shown at reference numeral 230 various artifacts and impairments are applied to the clean speech signals through an augmentation operation 232 to produce distorted speech 234. The artifacts and impairments may include background noise, reverberation, band limitation, packet loss, etc. In addition, an environment model, such as a room model, may be used to impact the clean speech signals. The distorted speech 234 is then input into the codec system 202.

The training process involves applying loss functions 240 to the reconstructed speech that is output by the audio decoder 222. The loss functions 240 may include a generative loss function 242 and an adversarial/discriminator loss function 244. The loss functions 250 output a reconstruction loss that, as shown at 250, is used to adjust parameters of the neural network models used by the audio encoder 210, vector quantizer 212, vector de-quantizer 220 and audio decoder 222, as shown at 252. Thus, the neural network models used by the audio encoder 210, vector quantizer 212, vector de-quantizer 220 and audio decoder 222 may be trained in an end-to-end hybrid manner using a mix of reconstruction and adversarial losses.

As a result of this training, the audio encoder 210 takes raw audio input and leverages a deep neural network to extract a comprehensive set of features that encapsulate intricate speech and background noise characteristics jointly or separately. The extracted speech features represent both the speech semantic as well as speech stationary attributes such as volume, pitch modulation, accent nuances, and more. This represents a departure from conventional audio codecs that rely on manually designed features. In the embodiments presented herein, the neural network audio codec systems learns and refines its feature extraction process from extensive and diverse datasets, resulting in a more versatile and generalized representation.

The output of the audio encoder 210 materializes as an embedding vector, with each vector encapsulating a snapshot of audio attributes over a timeframe. The vector quantizer 212 further compresses the embedding vector into a compact speech vector, i.e., codewords, using a residual vector quantization model. The codeword indices streams are ready for transmission or storage. At the receiving end, the audio decoder takes the compressed bitstream as input, reverses the quantization process, reconstructs the speech into time-domain waveforms.

The end-to-end training may result in a comprehensive and compact representation of clean speech. This is a data-driven compressed representation of speech, where the representation has a lower dimensionality that makes it easier to manipulate and utilize than if the speech were in its native domain. By “data-driven” it is meant that the representation of speech is developed or derived through ML-based training using real speech data, rather than a human conjuring the attributes for the representation. The data used to train the models may include a wide variety of samples of speech, languages, accents, different speakers, etc.

In the use case of speech enhancement, the compact speech vector represents “everything” needed to recover speech but discarding anything else related to artifacts or impairments. Thus, for speech enhancement applications, the neural network audio codec system does not encode audio, but rather, encodes only speech, discarding the non-speech elements. In so doing, the neural network audio codec system can achieve a more uniquely speech-related encoding, and that encoding is more compact because it does not express the other aspects that are included in the input audio. Training to encode speech is effectively training to reject everything else, and this can result in a stronger speech encoded foundation for any other transformation to or from speech.

### Loss Functions Useful During Training

Reconstruction losses may be used to minimize the error between the clean signal, known as a target signal, x and an enhanced signal generated by the neural network audio codec, denoted \hat{x}, which is denoised and de-reverberated and/or with concealed packet/frame loss of its input signal y, noisy, reverberated audio signal and/or with lost packets/frames. One or more reconstruction losses may be used in the time domain or time-frequency domain.

A loss in the time domain may involve minimizing a distance between estimated clean \hat{x} and the target signal x in the time domain:

$${ℒ}_{t} = {\sum }_{n = 1}^{N} \vert x [ n ] - \hat{x} [ n ] \vert ,$$

where [symbol] is the L1 norm loss and N denotes to number of samples of x and x in the time domain, where L1 Norm is a sum of the magnitudes of the vectors in a space and is one way to measure distance between vectors (sum of absolute difference of components of the vectors). In some implementations, the L1 norm loss and/or the L2 norm loss may be used.

A weighted signal-to-distortion radio (weighted SDR) may be used, where the input signal y is represented as x with additive noise n: y=x+n, then SDR loss is defined as:

$${ℒ}_{SDR} ( x , \hat{x} ) = - \frac{〈 x , \hat{x} 〉}{‖ x ‖ ‖ \hat{x} ‖} ,$$

where the operator [symbol] , [symbol] represents the inner product and ∥, ∥ represents Euclidean norm. This loss is phase sensitive with the range [−1,1]. For noise only samples, to be more precise, a noise prediction term is added to define the final weighted SDR loss:

$${ℒ}_{SDR} ( x , n , \hat{n} ) = {ℒ}_{SDR} ( x , \hat{x} ) + {ℒ}_{SDR} ( n , \hat{n} ) ,$$

where \hat{n}=y−\hat{x} is estimated noise.

Multi-scale Short-Time Fourier Transform (MS-STFT) operates in the frequency domain using different window lengths. This approach of using various window lengths is inspired by the Heisenberg Uncertainty Principle, which shows that a larger window length gives greater frequency resolution but lower time resolution, and the opposite for a shorter window length. Therefore, the MS-STFT uses a range of window lengths to capture different features of the audio waveform.

The loss is defined as:

$${ℒ}_{MSTFT} = {\sum }_{l = 1}^{L} {\sum }_{k = 1}^{K} \vert {S}^{w} [ l , k ] - {\hat{S}}^{w} [ l , k ] \vert + {α}_{w} {\sum }_{l = 1}^{L} {\sum }_{k = 1}^{K} \sqrt{{\vert log ( {S}^{w} [ l , k ] ) - log ( {\hat{S}}^{w} [ l , k ] ) \vert}^{2}} ,$$

where S^{w}[l, k] is the energy of the spectrogram at frame l and frequency bin k and characterized by a window w, K is the number of frequency bins, L is the number of frames and a_{w} is a parameter to balance between L1 Norm and L2 Norm part of the loss, where the L2 Norm is the square root of the sum of the entries of a vector. The second part of the loss is computed using a log operator to compress the values. Generally, most of the energy content of speech signal is concentrated below 4 kHz. Therefore, the energy magnitude in lower frequency components is significantly higher than higher frequency components, with going to log domain, the magnitude of higher frequencies and lower frequencies get closer, thus more focus on higher frequency components compared to linear scale. A high-pass filter can be designed to improve performance for high-frequency content.

A Mean Power Spectrum (MPS) loss function aims to minimize the discrepancy between the mean power spectra of enhanced and clean audio signals in the logarithmic domain using L2 Norm.

The power spectrum of the signal is computed as below:

$$P ( x ) = 1 / N {\sum }_{n = 0}^{N - 1} {\vert {X}_{n} \vert}^{2} ,$$

where P(x) is the mean power spectrum of signal x, X is FFT/STFT of signal x.

A logarithm may be applied to the mean power spectrum, such that the logarithmic power spectrum of a signal x is:

$$L ( x ) = 10 {log}_{10} ( P ( x ) + ϵ ) ,$$

where ϵ is a small constant to prevent the logarithm of zero.

The MPS loss between the enhanced and clean signals can then be defined as the L2 Norm of the difference between their logarithmic power spectra:

$$ℒoss ( \hat{x} , x ) = \sqrt{\sum {( L ( \hat{x} ) - L ( x ) )}^{2}} .$$

Generative Adversarial Networks (GANs) comprise two main models: generator and discriminator. In the neural network codec system, the audio encoder, vector quantizer and audio decoder may employ GAN generator and discriminator models. As an example, two adversarial loss functions could be used in the neural network audio codec system: Lease-squared adversarial loss functions and hinge loss functions.

Least square (LS) loss functions for discriminator and generator may be respectively defined as:

$${ℒ}_{ADV} ( D ; G ) = {E}_{( x , s )} [ {( D ( x ) - 1 )}^{2} + {D ( G ( y ) )}^{2} ] ,$$

$${ℒ}_{ADV} ( G ; D ) = {E}_{d} [ {D ( G ( y ) - 1 )}^{2} ] ,$$

For discriminator loss, [symbol] (D; G), E_{(,)} is the expectation operator, D(x), is the output of the discriminator for a real signal x, D(G(y)) is the discriminator output of enhanced (fake) signal and [symbol] (G; D) is the generator loss.

Hinge loss for the discriminator and generator may be defined as:

$${ℒ}_{ADV} ( D ; G ) = {E}_{( x , y )} [ max ( 1 - D ( x ) , 0 ) + max ( 0 , 1 + D ( G ( y ) ) ) ] ,$$

$${ℒ}_{ADV} ( G ; D ) = {E}_{y} [ max ( 1 - D ( G ( y ) ) , 0 ) ] ,$$

Hinge loss may be preferred over least square loss because in the case of discriminator loss, hinge loss tries to maximize the distance between the real signal and fake signal while LS loss tries to score 1 when the input is a “real signal” and 0 when the input is “fake signal”.

In addition to above-mentioned losses, feature matching may be used to minimize the difference between the intermediate features of each layer of real and generated signals when passed through the discriminator. Instead of solely relying on the final output of the discriminator, feature matching ensures that the generated samples have similar feature statistics to real samples at various levels of abstraction. This helps in stabilizing the training process of adversarial networks by providing smoother gradients. Feature matching loss may be defined as:

$${ℒ}_{FM} ( G ; D ) = {E}_{( x , y )} [ {\sum }_{i = 1}^{T} \frac{1}{{N}_{i}} {‖ {D}^{i} ( x ) - {D}^{i} ( G ( y ) ) ‖}_{1} ] ,$$

where Nᵢ is the number of layers in the discriminator D, and superscript i is used to design the layer number. Note that feature matching loss updates only generator parameters.

Several different discriminator models may be suitable for use in the training arrangement of FIG. 2, including: Multi-Scale Discriminator (MSD), Multi-Period Discriminator (MPD) and Multi-Scale Short-Time Fourier Transform (MS-STFT).

For a MSD, the discriminator is looking at the waveform at the different sampling rates. The waveform discriminators have the same network architecture but use different weights. Each network is composed of n number of strided 1-dimensional (1D) convolution blocks, an additional 1D convolution, and global average pooling to output a real-value score. A “leaky” rectifier linear unit (Leaky ReLu) may be used between the layers for the purpose of non-linearity of the network.

A MPD operates on the time-domain waveform and tries to capture implicit periodicity structure of the waveform. In an MPD discriminator, different periods of the waveform are considered. For each period, the same network architecture, with different weights, are used. The network consists of n strided two-dimensional (2D) convolution blocks, an additional convolution, and a global average pooling for outputting a scalar score. In the convolution block weight normalization may be used along with a Leaky ReLu as an activation function.

An MS-STFT discriminator, unlike the MSD and MPD, operates in the frequency domain using a Short-Time Fourier Transform (STFT). This discriminator enables the model to analyse the spectral content of the signal. The MS-STFT discriminator analyzes the “realness” of the signal at multiple time-frequency scales or resolutions. Having spectral content of the waveform in various resolutions, the model is able to analyze the “realness” of the waveform more profoundly. The MS-STFT discriminator may be composed of t equivalent networks that handle multi-scaled complex-valued STFTs with incremental window lengths and corresponding hop sizes. Each of these networks contains a 2D convolutional layer, with weight normalization applied, featuring a nxm kernel size and c number of channels, followed by a Leaky ReLu non-linear activation function. Subsequent 2D convolution layers have dilation rates in the temporal dimension and an output stride of j across the frequency axis. At the end we have dxd convolution with stride 1 followed by flatten layer to get the output scores.

Finally, the total loss of adversarial training may be defined as:

$$ℒ = {λ}_{FM} {ℒ}_{FM} + {λ}_{MSTFT} {ℒ}_{MSTFT} + {λ}_{G} {ℒ}_{ADV} ( G ; D ) + {λ}_{D} {ℒ}_{ADV} ( D ; G ) + {λ}_{t} {ℒ}_{t} + {λ}_{SDR} {ℒ}_{SDR} ,$$

where λ coefficients are used to give more weights to some losses compared to the other losses, [symbol] is the feature matching loss. [symbol] is MS-STFT loss that can be replaced by [symbol] for MSD discriminator or [symbol] for MPD discriminator.

Any one or more of the loss functions referred to above, or other loss functions now known or hereinafter developed, may be used in the training process depicted in FIG. 2. The architecture of the end-to-end training, from the encoder side to the decoder side, produces the embedding vectors that can be exploited for a variety of applications as described below. The training results in an embedding vector representation that lends itself to convergence, accuracy, etc. Again, this is a result of the characteristics that are trained for, selection of loss functions, training content, selection criteria for epics, etc., to arrive at the embedding vectors that have desirable characteristics of: rejecting non-speech (for speech enhancement applications), easy to encode speech, and durability across speech applications.

### Multi-Time Scale Audio Codec Streams

Presented herein after techniques for a data-driven audio coding approach that involves producing multiple compressed streams comprising encoded information (e.g., codeword indices) at different time scales (time intervals or frequency). This may allow for separation of different properties of speech, such as content and aspects of style (prosody), into the different compressed streams without explicitly enforcing it, i.e., in an unsupervised manner.

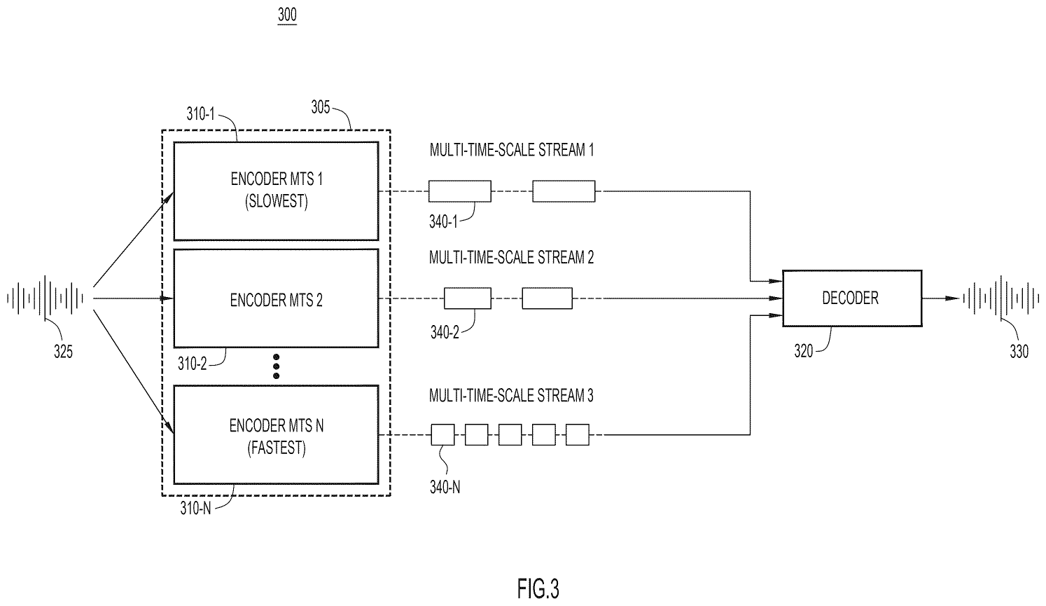

Reference is now made to FIG. 3. FIG. 3 shows a block diagram of a multi-time-scale (MTS) neural network audio codec system 300. The system 300 comprises an encoder block 305 that includes a plurality of audio encoders (encoders) 310-1 to 310-N and a decoder 320. The encoder block 305 receives input audio 325 to be encoded and generates multiple codeword sequences at different time intervals/scales/frequencies. The decoder 320 uses the multiple codeword sequences to reconstruct the original input audio to produce output audio 330. As described above, the encoders 310-1 to 310-N may include the vector quantization functions and the decoder 320 may include the vector de-quantization functions.

Each encoded stream output by the encoders 310-1 to 310-N has different properties, such as the audio frame rate. An audio frame rate is equivalent to a time scale, such that an encoded stream of a different frame rate is equivalent to saying the encoded stream has a different time scale. For example, encoder 310-1 generates a first encoded stream 340-1 at a first frame rate or frequency, encoder 310-2 generates a second encoded stream 340-2 at a second frame rate, and encoder 310-N generates a Nth encoded stream 340-N at frame rate N, where frame rate N is greater than frame rate N−1, which is greater than the second frame rate, which is greater than the first frame rate. The same audio is being encoded, multiple times (in parallel), but at different time scales/frame rates, to produce a plurality of encoded streams, each representative of the same input audio, but at different time scales. This may be achieved by a single encoder jointly encoding the plurality of encoded streams or by using a plurality of encoders running in parallel to produce the plurality of encoded streams. In the case of a single encoder, part of an encoder may be shared among streams and part of the encoder may be stream specific.

In one example, N=2 and thus there are two encoders that produce a set of two sequences at different time scales (frame rates): a fast sequence, and a slow sequence. The fast sequence could carry the fast-varying speech aspects such as meaning/content and the slow sequence could convey intonation, signal level, speaker attributes/identity, prosody, emotions, and other characteristics that exhibit gradual changes within the audio signal. In general, the fast sequence is designed to convey dynamic audio features that change rapidly. In contrast, the slow sequence is specifically designed to encapsulate static audio features that evolve slowly over time. The combination of the multiple streams at the decoder 320 allows to obtain the original audio signal while each of the streams may have different properties and represent different speech/sound aspects.

With the system 300, a sentence uttered twice by one speaker may have a similar fast code sequence (because the sentence is the same), but a completely different slow code sequence if the speaker attributes such as formant frequencies, pitch frequencies, timbre, and intonation change from the first utterance to the second utterance. While the discussion presented herein sometimes is directed to the two-stream scenario, this is by way of example only, and as shown in FIG. 3, the number of different time-scale streams may vary according to application.

Again, for the same audio content, one encoded stream in which codeword indices are sent very frequently and another encoded stream of codeword indices is generated that is sent less frequently. The encoded stream sent at the faster rate may contain more content (lexicon information) whereas the slower stream may contain prosody information and speaker characterization information. This is just an example. There is not necessary any enforcement of what each encoded stream contains. This is the result of the end-to-end training to separate the audio content and features of the speech so that one or more streams are sent more frequently and one or more other streams are sent less frequently. The decoder reconstructs the audio from the multiple streams and achieves better quality as a result.

Each encoder may use different encoder network hyper parameters such as: receptive field (the number of audio samples the encoder model uses to create a token in the encoded stream), different frequency, different embedding vector dimensionality, kernel size, number of channels, pooling size, etc. Each encoded stream may also have specific loss functions associated with a given slow/fast stream. Each encoded stream can have a different size and a different frequency of sending. Moreover, the frequency of sending can be variable as well, and decided/determined by the encoder based on the content of the speech/sound to be encoded.

As explained above, a neural network can be used to control, with the model design, the stride size of an encoder. The overall stride of the encoder defines how many samples are used to generate a new encoder output frame. If the stride is 160 samples at 16 kHz, then you generate 100 encoder output frames per second. A neural network architecture allows for adjusting the stride size and the field of view to use different combinations. For example, if using a convolutional neural network, there may be different “slice” so that the convolution has a different hop size to generate outputs. For example, one encoder can be generating embedding vectors every 10 msec and another encoder generating embedding vectors every 200 msecs, for example. This can be adjusted by tuning the hyper parameters of neural network layers that reduces dimension in the temporal axis, such as the stride in convolutional layers or pooling size in max-pooling layers as well as the number of such layers.

### Training Multi-Time-Scale Neural Network Codec System

The end-to-end training of the neural codec system is done in such a way to force the encoding of two or more different streams at different frequencies (time intervals). The information carried by each encoded time scale stream of the plurality of encoded time scale streams can be either explicitly or implicitly trained. In other words, it is not necessary for the data to be labeled for each type of speech content it contains and for the designer to decide to which stream he/she should allocate which content.

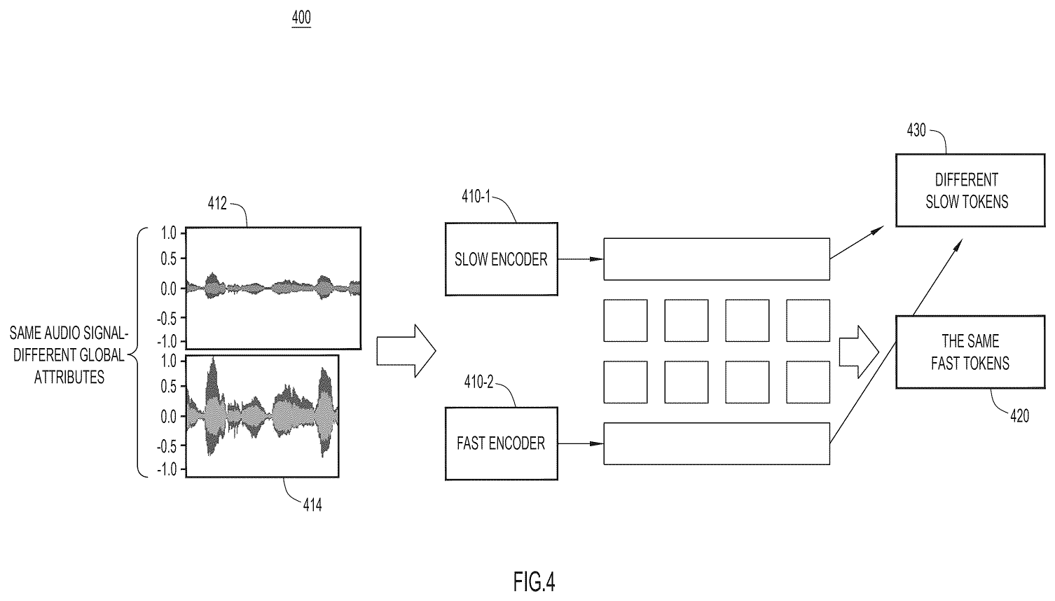

Reference is now made to FIG. 4, which illustrates a system 400 for training of a slow encoder 410-1 and a fast encoder 410-2 with pairs of audio 412 and 414 sharing the same phonetic content but different global attributes such as speaker characteristics and emotion. When training the system, the input signals may be appropriately rearranged so that the fast token sequences 420 produced by the fast encoder 410-2 are identical and only the slow token sequences 430 can differ. The slow token sequences 430 can encode global/slow varying attributes of audio. Typically, there are two completely separate encoders for fast and slow encoded streams, but it is also possible to use a single encoder with multiple outputs to generate both the fast encoded stream and the slow encoded stream. In the latter case, some part of the network is shared by all the output streams but some parts are output stream specific (a multi-headed network also known as Hydra network architecture).

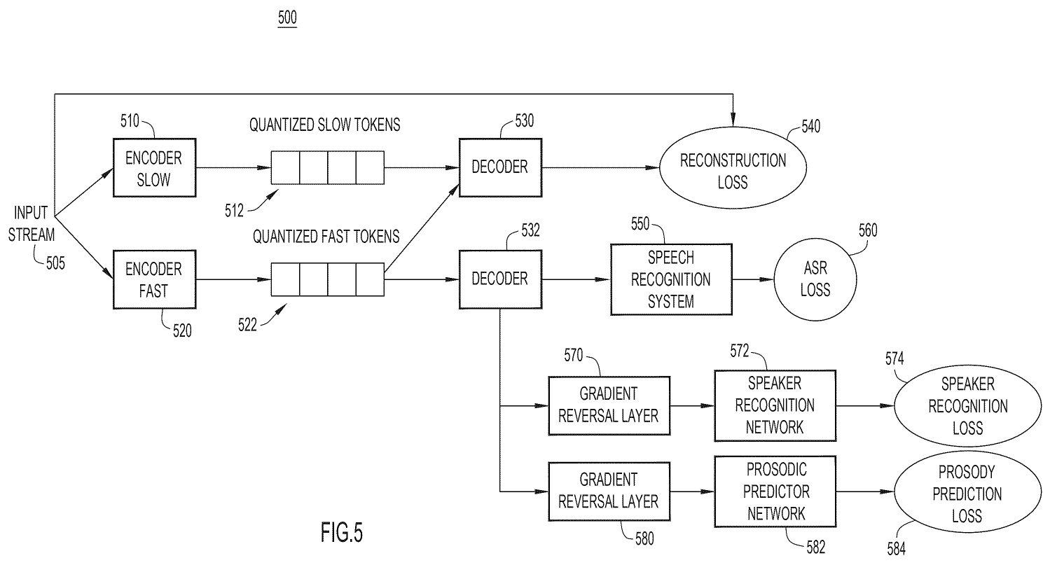

Such training involves multiple versions of audio with the same phonetic content but different global attributes such as speaker, emotion, and prosody. In case there is not access to such a training set (of multiple versions of the same audio phonetic content) that is large enough to train the system, other training methods may be used to enforce the multiple encoders to learn only the attributes of interest. This is depicted in FIG. 5. FIG. 5 shows a system 500 that enforces the encoders to learn only the attributes assigned to them by utilizing suitable losses. In the system 500, there is a slow encoder 510 and a fast encoder 520 that receive as input the same input audio stream 505. The slow encoder 510 is trained to generate a slow sequence stream 512 of quantized (slow) tokens and the fast encoder 520 is trained to generate a fast sequence stream 522 of quantized (fast) tokens. The system 500 further includes two decoders 530 and 532 that share their parameters. The decoders 530 and 532 always uses the fast tokens as input, but could optionally take the slow tokens as an additional input to condition on so that attributes contained in the slow tokens are also added to the output audio. Decoder 530 receives as input both the slow sequence stream 512 and the fast sequence stream 522, whereas decoder 532 receives as input only the fast sequence stream 522. The output of decoder 530 is run through a reconstruction loss process 540 that receives as input the input audio stream 505 and the output of the decoder 530. The output of decoder 532 is provided to a speech recognition system 550, the output of which is directed to an automatic speech recognition (ASR) process 560. In addition, the output of decoder 532 is directed to a speaker recognition adversarial processing chain that includes a gradient reversal layer 570, a speaker recognition neural network 572 and a speaker recognition loss process 574, as well as to a prosody adversarial processing chain that includes a gradient reversal layer 580, a prosodic neural network 582 and a prosody prediction loss process 584.

During training, when the decoder 532 is provided with only the fast sequence stream 522 generated by the fast encoder 520, the decoder 532 is configured to generate the phonetic content correctly with the speech recognition system 550 and associated ASR loss process 560. The output of the decoder 532 is also fed to the speaker recognition network 572 to predict speaker identity using speaker recognition loss process 574 (more global attributes) and emotional type content by the prosodic predictor neural network 582 and associated prosody prediction loss process 584.

The decoder 530 is fed both the slow sequence stream 512 and the fast sequence stream 522. The decoder 530 is configured to reconstruct the audio exactly using a reconstruction loss (of reconstruction loss process 540) either in time or frequency domain. Since the slow token stream 512 is provided tokens much less frequently, this bottleneck will prevent the slow encoder 510 from generating phonetic content.

Again, the fast token stream 522 does not have information about speaker identity and prosody because the system 500 does not take the output of the decoder 530 for the slow tokens and feed it back for speaker identity and prosody. The gradient reversal layers 570 and 580 will train the fast encoder 520 not to carry any speaker prosody information, by forcing the decoder 530 to take the speaker and prosody information from the slow sequence stream 512. When trained in this manner, one encoder can generate only speaker and prosody information and the other encoder can generate only phonetic content information. Putting the semantic information into the encoder architecture is done with loss functions and training configurations like these using a gradient reversal layer. Controlling the number of tokens generated can be done with convolution, how much information is pooled, etc.

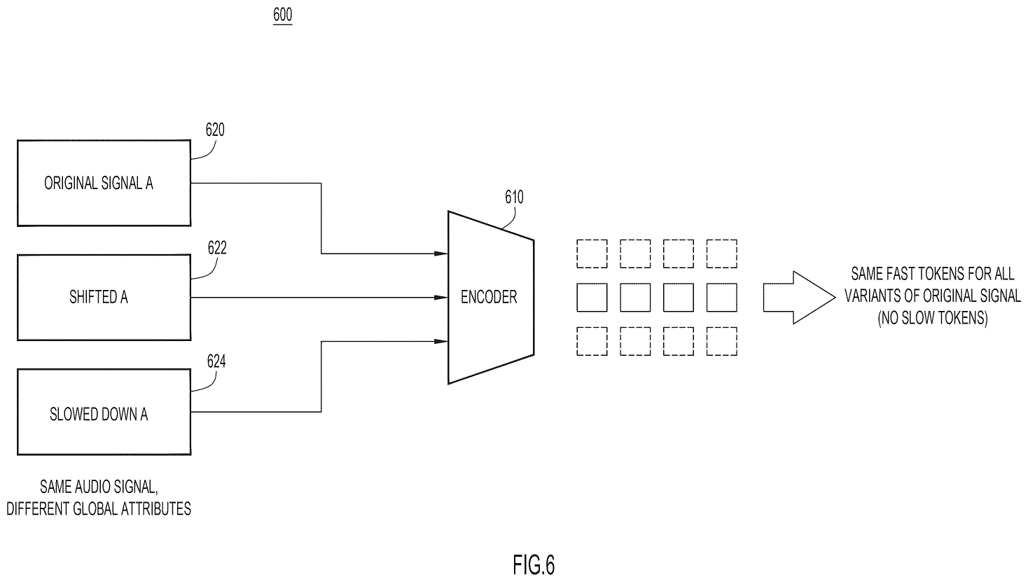

A variant of the slow-fast training approach could be to augment a given speech time interval or segment randomly in terms of speed and shifts and enforce that the embeddings/codes the same for the original and augmented segments. This may ensure that codes for a given speech segment remain the same even with a small shift or variability. This is shown in FIG. 6, which shows how a single encoder may be to produce the same fast tokens for an audio signal that has different global attributes. FIG. 6 is similar spirit to FIG. 4 except that there are no slow tokens generated. More specifically, FIG. 6 shows a system 600 comprising one encoder 610 that receives as input an original audio signal (A) 620, a shifted audio signal 622 and a slowed down audio signal 624. The encoder 610 is trained to generate the same fast tokens for all variants of the original signal. No slow tokens are generated. Thus, the difference from the training arrangement of FIG. 4 is that this arrangement does not require two different networks but the same network (weights and architecture are shared). This is useful for applications that involve the content of the speech and not the style, e.g. automatic speech recognition or direct speech input to a large language model.

### Adapting/Adjusting the Frequency of the Encoded Streams

A random speaker may have speech attributes that vary at a frequency different than what the network was trained for. Without loss of generality, it is assumed that the speaker's stream varies slower than the frequency at which it is sent. On the decoder side, this suggests that a preceding token from that stream can be used to recreate the current speech segment. To implement this, a process may be provided on the encoder side to detect that it is possible to lower the frequency of sending that stream. The logic for such a process can be implemented in several ways:
1. A predictor network is provided that makes a prediction for the next token given the history of the previously sent tokens. If the predictor network performance is low, namely the next token cannot be well predicted, then that next token is sent. If the encoder can predict well the next codewords to be sent, then it is assumed that the decoder side also can predict it well, and this can inform whether or not to make a change to the frequency of sending a stream.
2. A low-complexity decoder can be used on the transmit side to decide whether or not to send the tokens of a slow stream. The low-complexity decoder will run at the transmit side twice, once with the new slow changing tokens of the given stream and once with the previously sent tokens. If the output of the low-complexity decoder changes above a certain threshold on some loss metrics (L2 Norm, L1 Norm, GED, etc.) then the new tokens are sent; otherwise the new tokens of that slow changing stream are not sent, and the decoder at the receive size will keep using the previously sent tokens.
3. Instead of having a full decoder running on the transmit side, a small neural network is provided that takes an embedding (slow) token sequence from the encoder output to indicate whether the output of the decoder changes above a certain level with respect to the output when using the previous token sequence.
   In an extreme case, some attributes might not change at all, and the encoder might decide to stop sending the tokens related to those attributes.

### Use Cases

The slow stream and fast stream approach is useful to divide the audio stream into local and global information, where the fast stream of tokens carries phonetic (content) information, and the slow stream could carry emotion, speaker attributes, accent, etc.

### 1. Text to Speech (TTS)

The proposed multi-time-scale neural codec could be useful to expedite the development of a TTS encoder module with different speaker identities as well as a prosody-controllable TTS encoder module. With the combination of training strategies as shown in FIG. 5 and changes in the network architecture for pooling fast and slow streams, the fast stream could be trained to represent the phonetic content and the slow stream could be trained to maintain speaker-specific attributes. From the slow stream, speaker identity such as fundamental frequency shift and prosody including rhythm, pause, loudness and melody may be derived from the slow stream. Based on offline analysis of slow streams of various speakers, speaker profiles can be constructed and stored. A high-level model can also be built to control the prosody and speaker identity.

### 2. Emotion Recognition, Volume Level Detection, Speech Prosody Analysis

An application for slow tokens is emotion recognition, collection of signal metrics such as volume level, and analysis of speech prosody. Both streams could be used jointly for speech reconstruction.

### 3. Redundant Audio Data (RED)

In audio packet loss situations, a fast changing encoded stream of the speech can be transmitted and a slow changing encoded stream can be used to reconstruct missing or lost audio. This example use case is now explained in more detail.

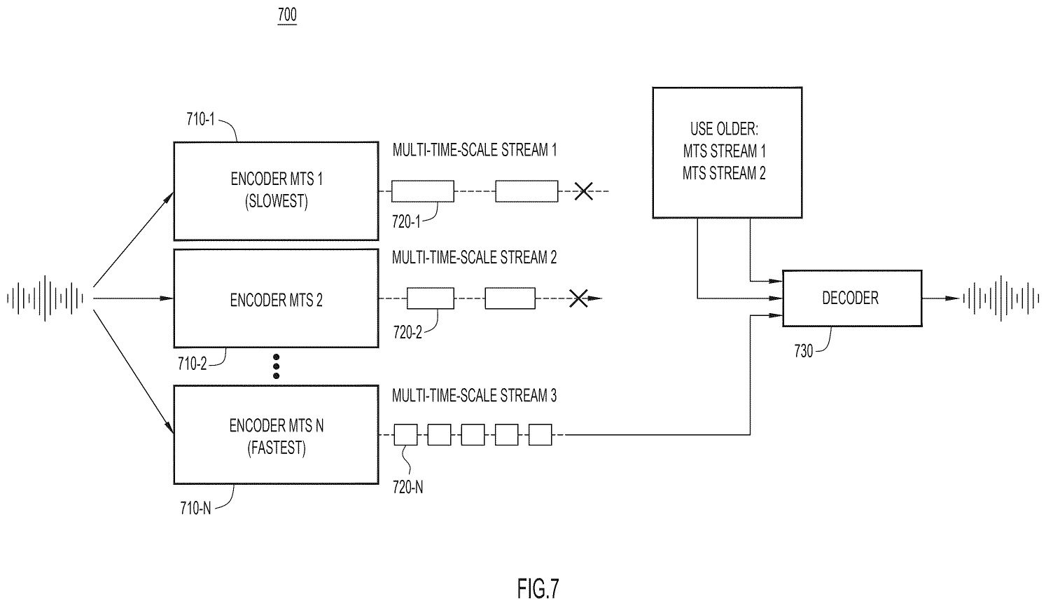

To address the packet loss issue, redundant audio data is used to recover the previously lost packets. In the system 700 of FIG. 7, there are a plurality of encoders 710-1, 710-2, . . . , 710-N to transmit the slowest to the fastest streams 720-1, 720-2, . . . , 720-N. A decoder 730 receives all of the streams 720-1, 720-2, . . . , 720-N.

When transmitting redundant information about the previous packet together with the current packet (so called RED packets), on the transmit side only the fast-changing stream component of the previous frame may be sent. On the receive side, the slow-changing stream component from the current frame can be used together with the fast-changing component of the previous frame in order to decode the previous frame. Thus, as shown in FIG. 7, the streams 720-1 and 720-2 for the current frame are used together with the stream 720-1 of the previous frame to decode the previous frame lost in the slower streams 720-1 and 720-2.

### 4. Different Compression for Slow and Fast Changing Components

Fast tokens can be used to transmit the phonetic information in the speech with an exceedingly high compression rate (such as at 0.05-0.2 kbps) and a slow token stream is used to transmit the global contents like emotion, speaker attributes, accent every second or when there are any changes occurring in the emotion of the speech.

### 5. Speech Morphing

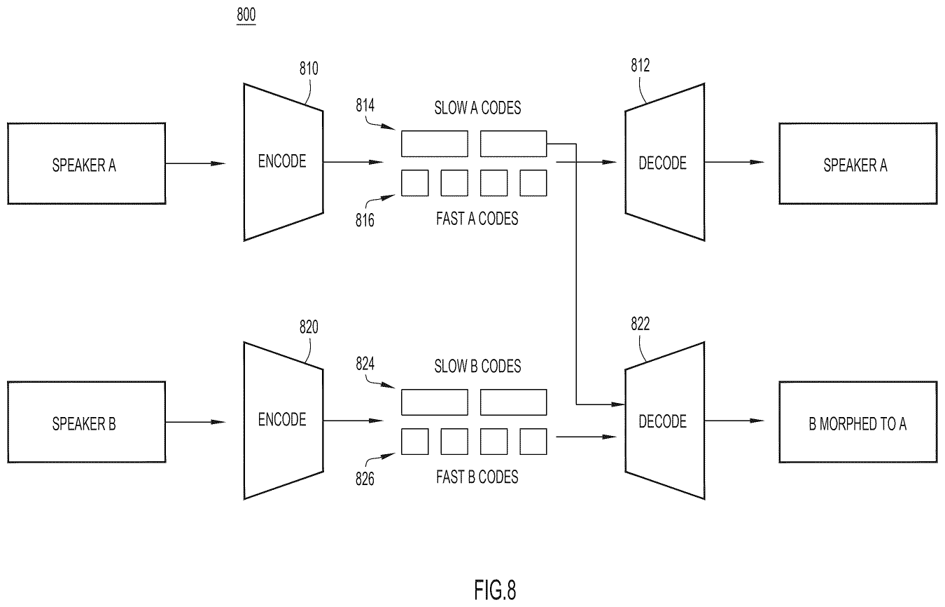

Still another application of multi-time-scale streams is to morph the speech such that it has desired global characteristics such as speaker identity and emotion. A system 800 that can enable this capability is shown in FIG. 8. The system 800 includes an encoder 810 and decoder 812 for a first speaker, Speaker A, and an encoder 820 and decoder 822 for a second speaker, Speaker B. Voice audio for Speaker A is run through the encoder 810 to decoder 822, and voice audio for Speaker B is run through the encoder 820 to the decoder 822. Encoder 810 generates a slow token stream 814 and a fast token stream 816 for Speaker A. Encoder 820 generates a slow token stream 824 and a fast token stream 826. The slow token stream 824 for speaker B may be replaced with a pre-generated slow token stream of an anonymous speaker (e.g., Speaker A), slow token stream 814 of Speaker A, for speaker anonymization or fixing a speaker emotion to a particular tone, e.g., a neutral tone. This associates the properties of speech of Speaker A to the speech content of Speaker B resulting in morphed speech. This could be a useful feature for call centers.

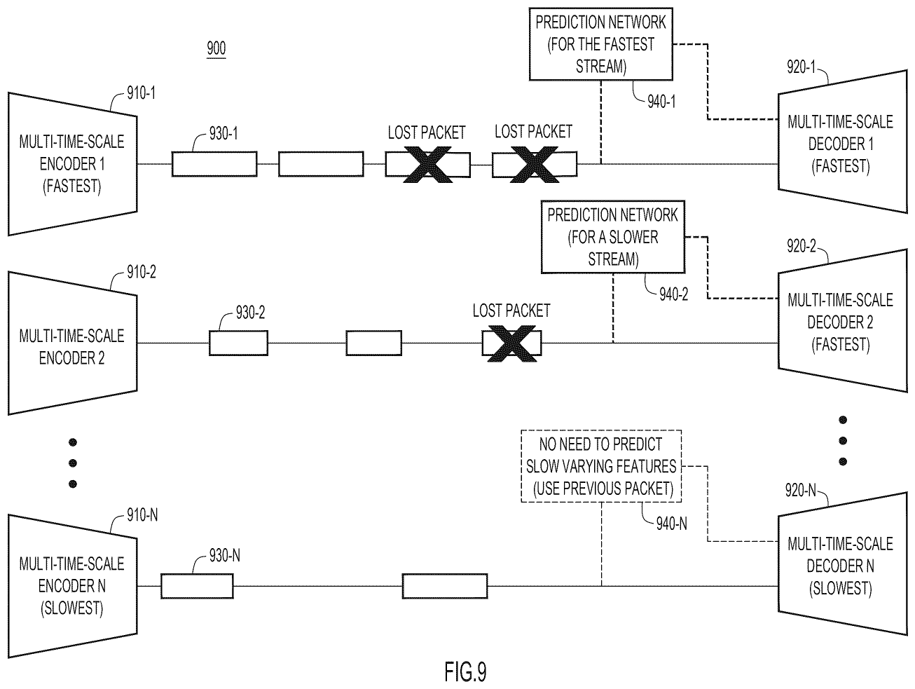

FIG. 9 shows a block diagram of a system 900 in which streams are predicted, such as for predictive coding or packet loss concealment applications. The system 900 includes a plurality of multi-time-scale encoders 910-1, 910-2, . . . 910-N and a plurality of multi-time-scale decoders 920-1, 920-2, . . . 920-N. The encoder 910-1 generates the fastest encoded stream 930-1, encoder 910-2 encodes a slower stream 930-2, and encoder 910-N generates the slowest encoded stream 930-N. Similarly, decoder 920-1 decodes the fasted stream from encoder 910-1, decoder 920-2 decodes the slower stream from encoder 910-2, and decoder 920-N decodes the slowest stream from encoder 910-1. In one example, a first prediction network 940-1 is provided for the fastest encoded stream 930-1 and a second prediction network 940-2 is provided for the slower encoded stream 930-2. As shown at 940-N, there may be no need to predict slow varying features in the slowest encoded stream 930-N since the predictions are done for all other encoded streams; rather the previous packet may be used.

In the arrangement of FIG. 9, separate prediction may be performed for each of the streams (this is shown for encoded streams 930-1 and 930-2 only, as an example) to predict a lost or missing audio packet. The prediction of the fastest encoded stream 930-1 is prioritized and the prediction of all other streams is considered optional and conditioned on the frequency of the encoded stream (sending rate) and an available compute budget. The prediction can be done on the encoder side in the case of predictive encoding or on the decoder side only for the application in packet-loss concealment. FIG. 9 also shows an example where the prediction is done on the decoder side.

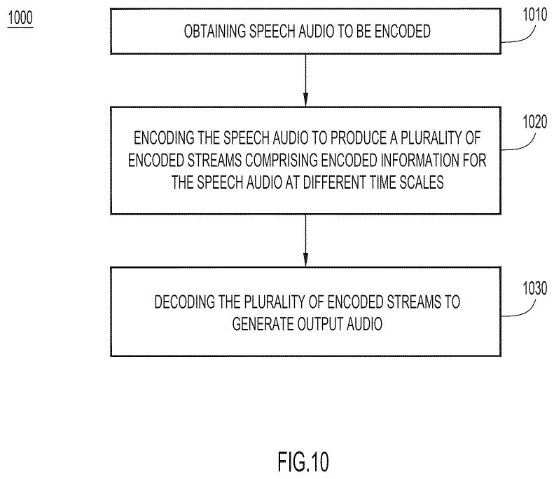

FIG. 10 illustrates a flow chart depicting a method 1000 according to an example embodiment. The method 1000 includes, at step 1010, obtaining speech audio to be encoded. At step 1020, the method 1000 includes encoding the speech audio to produce a plurality of encoded streams comprising encoded information for the speech audio at different time scales. At step 1030, the method 1000 includes decoding the plurality of encoded streams to generate output audio.

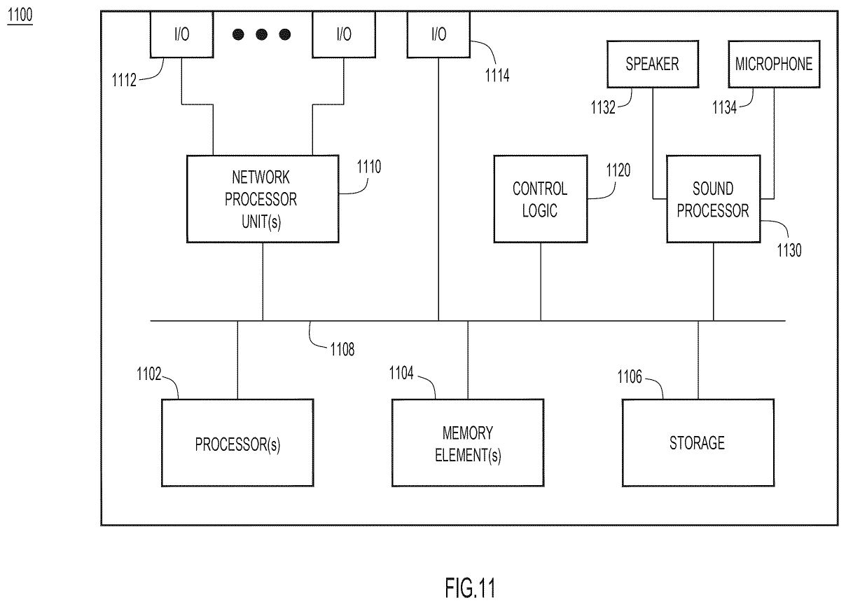

FIG. 11 is a hardware block diagram of a networking/computing device/apparatus/appliance/endpoint that may perform functions associated with any combination of operations in connection with the techniques depicted in FIGS. 1-10 described herein. It should be appreciated that FIG. 11 provides only an illustration of one example embodiment and does not imply any limitations with regard to the environments in which different example embodiments may be implemented. Many modifications to the depicted environment may be made.

In at least one embodiment, the computing device 1100 may be any apparatus that may include one or more processor(s) 1102, one or more memory element(s) 1104, storage 1106, a bus 1108, one or more network processor unit(s) 1110 interconnected with one or more network input/output (I/O) interface(s) 1112, one or more I/O interface(s) 1114, and control logic 1120. In various embodiments, instructions associated with logic for computing device 1100 can overlap in any manner and are not limited to the specific allocation of instructions and/or operations described herein.

In at least one embodiment, processor(s) 1102 is/are at least one hardware processor configured to execute various tasks, operations and/or functions for device 1100 as described herein according to software and/or instructions configured for device 1100. Processor(s) 1102 (e.g., a hardware processor) can execute any type of instructions associated with data to achieve the operations detailed herein. In one example, processor(s) 1102 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 1104 and/or storage 1106 is/are configured to store data, information, software, and/or instructions associated with device 1100, and/or logic configured for memory element(s) 1104 and/or storage 1106. For example, any logic described herein (e.g., control logic 1120) can, in various embodiments, be stored for device 1100 using any combination of memory element(s) 1104 and/or storage 1106. Note that in some embodiments, storage 1106 can be consolidated with one or more memory elements 1104 (or vice versa), or can overlap/exist in any other suitable manner. In one or more example embodiments, process data is also stored in the one or more memory elements 1104 for later evaluation and/or process optimization.

In at least one embodiment, bus 1108 can be configured as an interface that enables one or more elements of device 1100 to communicate in order to exchange information and/or data. Bus 1108 can be implemented with any architecture designed for passing control, data and/or information between processors, memory elements/storage, peripheral devices, and/or any other hardware and/or software components that may be configured for device 1100. In at least one embodiment, bus 1108 may be implemented as a fast kernel-hosted interconnect, potentially using shared memory between processes (e.g., logic), which can enable efficient communication paths between the processes.

In various embodiments, network processor unit(s) 1110 may enable communication between computing device 1100 and other systems, entities, etc., via network I/O interface(s) 1112 (wired and/or wireless) to facilitate operations discussed for various embodiments described herein. In various embodiments, network processor unit(s) 1110 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1100 and other systems, entities, etc. to facilitate operations for various embodiments described herein. In various embodiments, network I/O interface(s) 1112 can be configured as one or more Ethernet port(s), Fibre Channel ports, any other I/O port(s), and/or antenna(s)/antenna array(s) now known or hereafter developed. Thus, the network processor unit(s) 1110 and/or network I/O interface(s) 1112 may include suitable interfaces for receiving, transmitting, and/or otherwise communicating data and/or information in a network environment.

I/O interface(s) 1114 allow for input and output of data and/or information with other entities that may be connected to device 1100. For example, I/O interface(s) 1114 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards.

In various embodiments, control logic 1120 can include instructions that, when executed, cause processor(s) 1102 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1120) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In the even the device 1100 is an endpoint (such as telephone, mobile phone, desk phone, conference endpoint, etc.), then the device 1100 may further include a sound processor 1130, a speaker 1132 that plays out audio and a microphone 1134 that detects audio. The sound processor 1130 may be an sound accelerator card or other similar audio processor that may be based on one or more ASICs and associated digital-to-analog and analog-to-digital circuitry to convert signals between the analog domain and digital domain. In some forms, the sound processor 1130 may include one or more digital signal processors (DSPs) and be configured to perform some or all of the operations of the techniques presented herein.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 1106 and/or memory elements(s) 1104 can store data, software, code, instructions (e.g., processor instructions), logic, parameters, combinations thereof, and/or the like used for operations described herein. This includes the storage 1106 and/or memory elements(s) 1104 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In some aspects, the techniques described herein relate to a method including: obtaining speech audio to be encoded; encoding the speech audio to produce a plurality of encoded streams including encoded information for the speech audio at different time scales; and decoding the plurality of encoded streams to generate output audio.

In some aspects, the techniques described herein relate to a method, wherein the encoded information includes codeword indices generated using a neural network audio codec system including an audio encoder and an audio decoder trained end-to-end.

In some aspects, the techniques described herein relate to a method, wherein the audio encoder is trained with multiple versions of audio sharing the same phonetic content but different global attributes including speaker, emotion and/or prosody.

In some aspects, the techniques described herein relate to a method, wherein the multiple versions of audio are a result of randomly changing a speed or time shift given time interval or segment of the speech audio to produce augmented segments and enforcing the encoded information to be the same for the speech audio and the augmented segments.

In some aspects, the techniques described herein relate to a method, wherein respective ones of the plurality of encoded streams carry different properties of the speech audio.

In some aspects, the techniques described herein relate to a method, wherein encoding includes encoding the speech audio with a plurality of audio encoders each of which generates a corresponding encoded stream of the plurality of encoded streams.

In some aspects, the techniques described herein relate to a method, wherein the plurality of audio encoders are configured with different encoder parameters including one or more of: number of audio samples used to create a token in an encoded stream, frequency of tokens in the encoded stream, embedding vector dimensionality, and loss function used to train an audio encoder.

In some aspects, the techniques described herein relate to a method, wherein the plurality of audio encoders are trained by enforcing respective ones of the plurality of audio encoders to learn only certain attributes of speech audio using one more loss functions.

In some aspects, the techniques described herein relate to a method, wherein encoding produces one or more encoded streams of the plurality of encoded streams that are at a faster time scale to represent faster-varying aspects of the speech audio and one or more encoded streams of the plurality of encoded streams that are at a slower time scale to represent slower-varying aspects of the speech audio.

In some aspects, the techniques described herein relate to a method, further including adjusting a time scale of one or more of the plurality of encoded streams based on the speech audio to be encoded.

In some aspects, the techniques described herein relate to a method, wherein adjusting includes reducing the time scale of one or more of the plurality of encoded streams based on ease of prediction of future encoded information from previously generated encoded information.

In some aspects, the techniques described herein relate to a method, further including: transmitting redundant information about a previous audio packet together with a current audio packet by transmitting only a higher sending rate encoded stream for the previous audio packet and transmitting the plurality of encoded streams for the current audio packet, wherein decoding includes decoding the longer time scale encoded stream from the current audio packet with the shorter time scale encoded stream for the previous audio packet in order to reconstruct the previous audio packet.

In some aspects, the techniques described herein relate to a method, wherein encoding includes: encoding first speech audio for a first speaker to produce at least a first encoded stream at a first time scale and a second encoded stream at a second time scale; encoding second speech audio for a second speaker to produce at least a first encoded stream at a first time scale and a second encoded stream at a second time scale; wherein decoding includes decoding the first encoded stream for the first speech audio and the second encoded stream for the second speech audio to generate output audio that associates properties of the first speaker to speech content of the second speech audio of the second speaker.

In some aspects, the techniques described herein relate to a system including: an audio encoder configured to encode speech audio to produce a plurality of encoded streams including encoded information for the speech audio at different time scales; and an audio decoder configured to decode the plurality of encoded streams to generate output audio.

In some aspects, the wherein the audio encoder and the audio decoder of the system are trained end-to-end as part of a neural network audio codec system.

In some aspects, the techniques described herein relate to an apparatus including: one or more processors configured to obtain speech audio and to encode the speech audio produce a plurality of encoded streams including encoded information for the speech audio at different time scales; and a communication interface configured to transmit the plurality of encoded streams for processing by an audio decoder that decodes the plurality of encoded streams to generate output audio.

In some aspects, the one or more processors of the apparatus execute instructions for an audio encoder that is part of neural network audio codec system that includes the audio encoder and an audio decoder trained end-to-end, wherein the audio encoder is trained with multiple versions of audio sharing the same phonetic content but different global attributes including speaker, emotion and/or prosody.

In some aspects, the one or more processors of the apparatus execute instructions for a plurality of audio encoders each of which generates a corresponding encoded stream of the plurality of encoded streams.

In some aspects, the plurality of audio encoders are configured with different encoder parameters including one or more of: number of audio samples used to create a token in an encoded stream, frequency of tokens in the encoded stream, embedding vector dimensionality, and loss function used to train the audio encoder.

In some aspects, the plurality of audio encoders are trained by enforcing respective ones of the plurality of audio encoders to learn only certain attributes of speech audio using one more loss functions.

In some aspects, the techniques described herein relate to one or more non-transitory computer readable storage media encoded with instructions that, when executed by a processor, cause the processor to perform operations including: obtaining speech audio to be encoded; encoding the speech audio to produce a plurality of encoded streams including encoded information for the speech audio at different time scales; and transmitting the plurality of encoded streams to an audio decoder that decodes the plurality of encoded streams to generate output audio.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining speech audio to be encoded;
encoding the speech audio to produce a plurality of encoded streams comprising encoded information for the speech audio at different time scales; and
decoding the plurality of encoded streams to generate output audio.

2. The method of claim 1, wherein the encoded information comprises codeword indices generated using a neural network audio codec system comprising an audio encoder and an audio decoder trained end-to-end.

3. The method of claim 2, wherein the audio encoder is trained with multiple versions of audio sharing the same phonetic content but different global attributes including speaker, emotion and/or prosody.

4. The method of claim 3, wherein the multiple versions of audio are a result of randomly changing a speed or time shift given time interval or segment of the speech audio to produce augmented segments and enforcing the encoded information to be the same for the speech audio and the augmented segments.

5. The method of claim 1, wherein respective ones of the plurality of encoded streams carry different properties of the speech audio.

6. The method of claim 1, wherein encoding comprises encoding the speech audio with a plurality of audio encoders each of which generates a corresponding encoded stream of the plurality of encoded streams.

7. The method of claim 6, wherein the plurality of audio encoders are configured with different encoder parameters including one or more of: number of audio samples used to create a token in an encoded stream, frequency of tokens in the encoded stream, embedding vector dimensionality, and loss function used to train the audio encoder.

8. The method of claim 6, wherein the plurality of audio encoders are trained by enforcing respective ones of the plurality of audio encoders to learn only certain attributes of speech audio using one more loss functions.

9. The method of claim 1, wherein encoding produces one or more encoded streams of the plurality of encoded streams that are at a faster time scale to represent faster-varying aspects of the speech audio and one or more encoded streams of the plurality of encoded streams that are at a slower time scale to represent slower-varying aspects of the speech audio.

10. The method of claim 1, further comprising adjusting a time scale of one or more of the plurality of encoded streams based on the speech audio to be encoded.

11. The method of claim 10, wherein adjusting comprises reducing the time scale of one or more of the plurality of encoded streams based on ease of prediction of future encoded information from previously generated encoded information.

12. The method of claim 1, further comprising:
transmitting redundant information about a previous audio packet together with a current audio packet by transmitting only a higher sending rate encoded stream for the previous audio packet and transmitting the plurality of encoded streams for the current audio packet,
wherein decoding comprises decoding a longer time scale encoded stream from the current audio packet with a shorter time scale encoded stream for the previous audio packet in order to reconstruct the previous audio packet.

13. The method of claim 1, wherein encoding comprises:
encoding first speech audio for a first speaker to produce at least a first encoded stream at a first time scale and a second encoded stream at a second time scale; and
encoding second speech audio for a second speaker to produce at least a first encoded stream at a first time scale and a second encoded stream at a second time scale,
wherein decoding comprises decoding the first encoded stream for the first speech audio and the second encoded stream for the second speech audio to generate output audio that associates properties of the first speaker to speech content of the second speech audio of the second speaker.

14. A system comprising:
an audio encoder configured to encode speech audio to produce a plurality of encoded streams comprising encoded information for the speech audio at different time scales; and
an audio decoder configured to decode the plurality of encoded streams to generate output audio.

15. The system of claim 14, wherein the audio encoder and the audio decoder are trained end-to-end as part of a neural network audio codec system.

16. The system of claim 15, wherein the audio encoder is trained with multiple versions of audio sharing the same phonetic content but different global attributes including speaker, emotion and/or prosody.

17. The system of claim 16, wherein the multiple versions of audio are a result of randomly changing a speed or time shift given time interval or segment of the speech audio to produce augmented segments and enforcing the encoded information to be the same for the speech audio and the augmented segments.

18. The system of claim 14, and further comprising a plurality of audio encoder each of which generates a corresponding encoded stream of the plurality of encoded streams.

19. The system of claim 18, wherein the plurality of audio encoders are configured with different encoder parameters including one or more of: number of audio samples used to create a token in an encoded stream, frequency of tokens in the encoded stream, embedding vector dimensionality, and loss function used to train an audio encoder.

20. The system of claim 18, wherein the plurality of audio encoders are trained by enforcing respective ones of the plurality of audio encoders to learn only certain attributes of speech audio using one more loss functions.

21. An apparatus comprising:
one or more processors configured to obtain speech audio and to encode the speech audio produce a plurality of encoded streams comprising encoded information for the speech audio at different time scales; and
a communication interface configured to transmit the plurality of encoded streams for processing by an audio decoder that decodes the plurality of encoded streams to generate output audio.

22. The apparatus of claim 21, wherein the one or more processors execute instructions for an audio encoder that is part of neural network audio codec system that includes the audio encoder and an audio decoder trained end-to-end, wherein the audio encoder is trained with multiple versions of audio sharing the same phonetic content but different global attributes including speaker, emotion and/or prosody.

23. The apparatus of claim 22, wherein the multiple versions of audio are a result of randomly changing a speed or time shift given time interval or segment of the speech audio to produce augmented segments and enforcing the encoded information to be the same for the speech audio and the augmented segments.

24. The apparatus of claim 21, wherein the one or more processors execute instructions for a plurality of audio encoders each of which generates a corresponding encoded stream of the plurality of encoded streams.

25. The apparatus of claim 24, wherein the plurality of audio encoders are configured with different encoder parameters including one or more of: number of audio samples used to create a token in an encoded stream, frequency of tokens in the encoded stream, embedding vector dimensionality, and loss function used to train the audio encoder.
